(19) United States
(12) Patent Application Publication
(10) Pub. No.: US 2026/0228686 A1
(43) Pub. Date: Aug. 6, 2026

(54) SYSTEM AND METHOD FOR TRACKING PLACEMENT OF SLOTS ON SHELVES IN A FACILITY AND SUGGESTING ALTERNATE PRODUCT TYPES FOR RESTOCKING SLOTS

(71) Applicant: Simbe Robotics, Inc., Burlingame, CA (US)

(72) Inventors: Jariullah Safi, South San Francisco, CA (US); Bradley Bogolea, South San Francisco, CA (US); Tom Gehani, South San Francisco, CA (US)

(21) Appl. No.: 19/631,092

(22) Filed: Mar. 27, 2026

Related U.S. Application Data
(63) Continuation-in-part of application No. 18/083,288, filed on Dec. 16, 2022.
(60) Provisional application No. 63/290,591, filed on Dec. 16, 2021.
(60) Provisional application No. 63/778,905, filed on Mar. 27, 2025.

(51) Int. Cl. G06Q 10/087; G06T 7/13; G06V 10/77; G06V 20/52

(52) U.S. Cl. CPC G06Q 10/08724; G06Q 10/08726; G06Q 10/08743; G06Q 10/0877; G06T 7/13; G06V 10/7715; G06V 20/52; G06V 2201/07

(57) ABSTRACT

One variation of a method includes: accessing an image captured by a robotic system autonomously navigating throughout a facility; identifying a slot on an inventory structure based on a location of a shelf tag, including a first product identifier, in the image; and detecting an object within the slot. In response to the object differing from a first template image associated with the first product identifier: interpreting absence of a first product type associated with the first product identifier in the slot; and detecting an adjacent shelf tag, including a second product identifier, arranged on the inventory structure in the image. In response to the object corresponding to a second template image associated with the second product identifier, confirming presence of the second product type in the slot; generating a report indicating detection of a stocking error event; and transmitting the report to a facility associate.

### CROSS-REFERENCE

This Application claims the benefit of U.S. Provisional Application No. 63/778,905, filed on 27-MAR-2025, and is a Continuation-In-Part of U.S. patent application Ser. No. 18/083,288, filed on 16-DEC-2022, which claims the benefit of U.S. Provisional Application No. 63/290,591, filed on 16-DEC-2021, each of which is incorporated in its entirety by this reference.

### TECHNICAL FIELD

This invention relates generally to the field of stock tracking and, more specifically, to a new and useful method for tracking placement of product on shelves in a facility in the field of stock tracking.

### BRIEF DESCRIPTION OF THE FIGURES

FIGS. 1A, 1B, 1C, and 1D are flowchart representations of a method;

FIG. 2 is a flowchart representation of one variation of the method;

FIG. 3 is a flowchart representation of one variation of the method;

FIG. 4 is a flowchart representation of one variation of the method;

FIG. 5 is a flowchart representation of one variation of the method; and

FIG. 6 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

1. Method: Detect Product “spread”

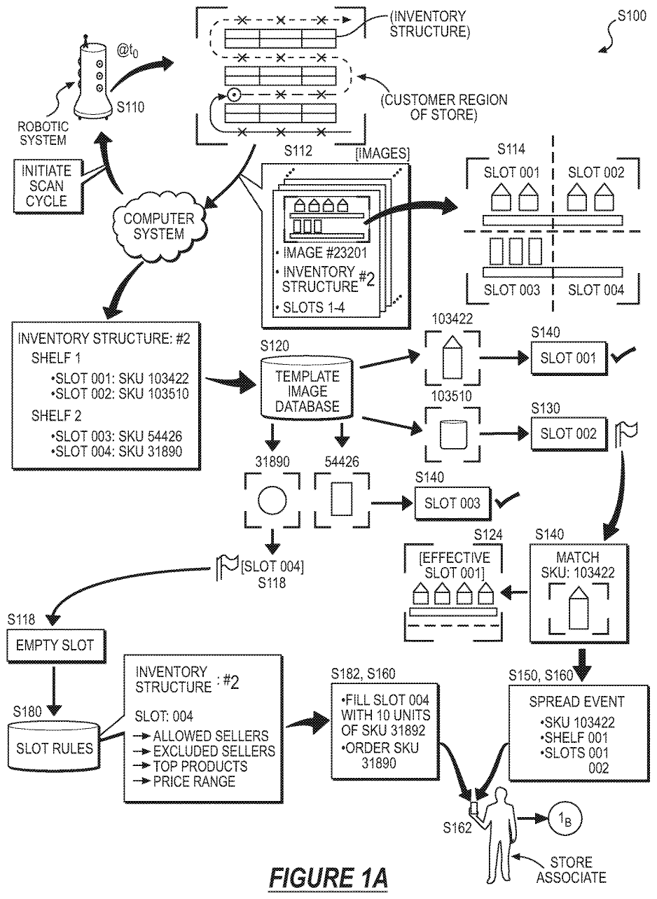

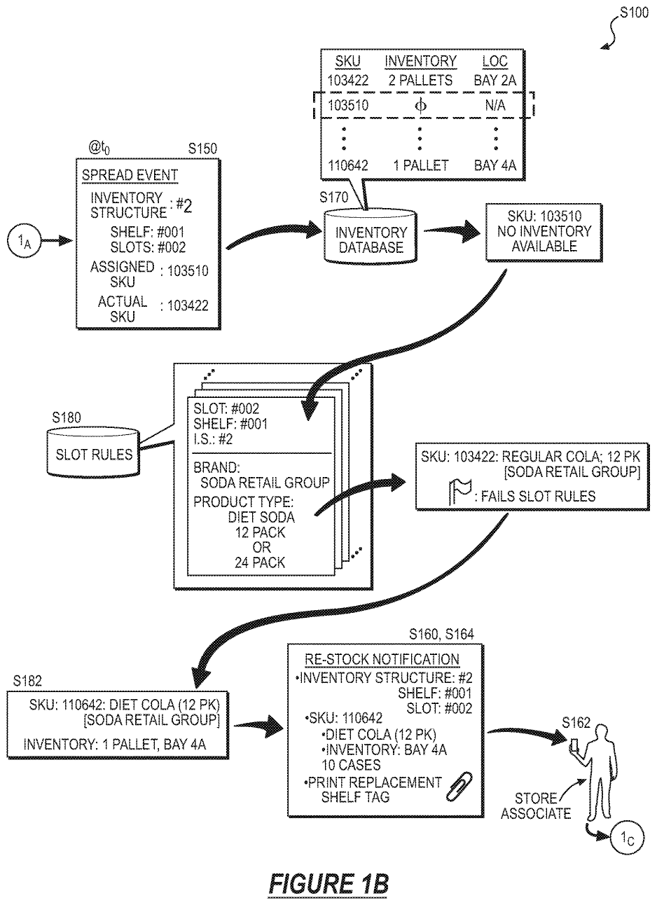

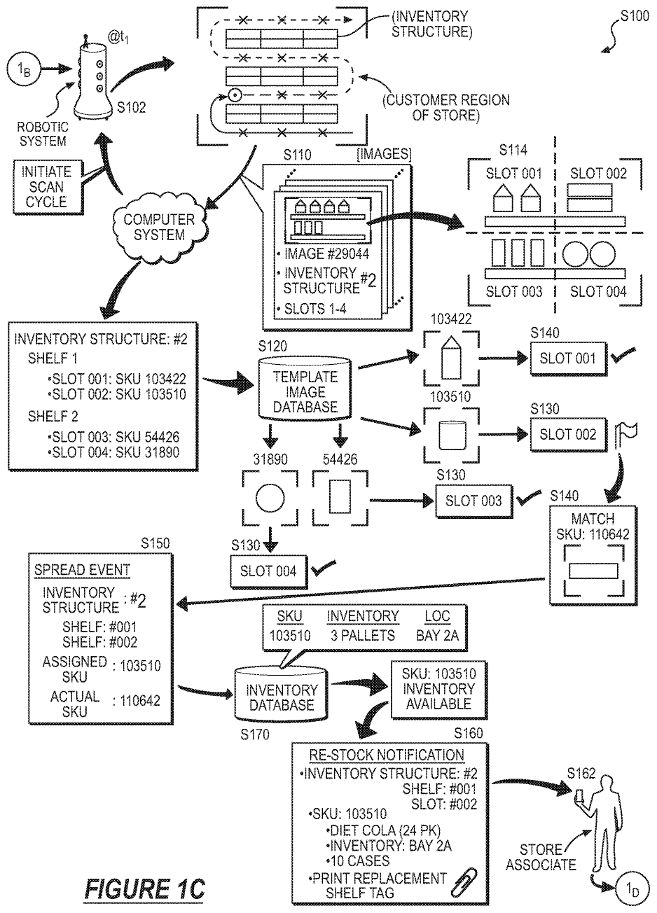

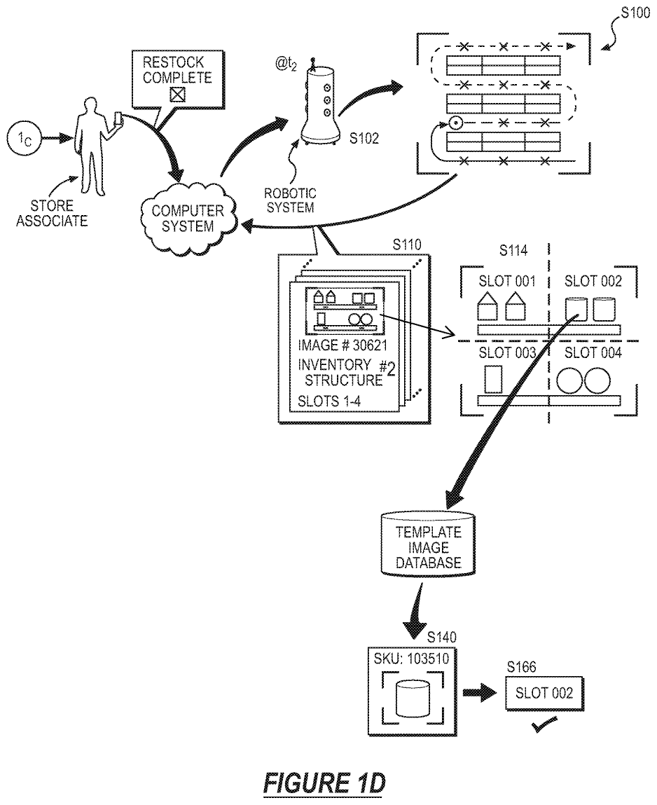

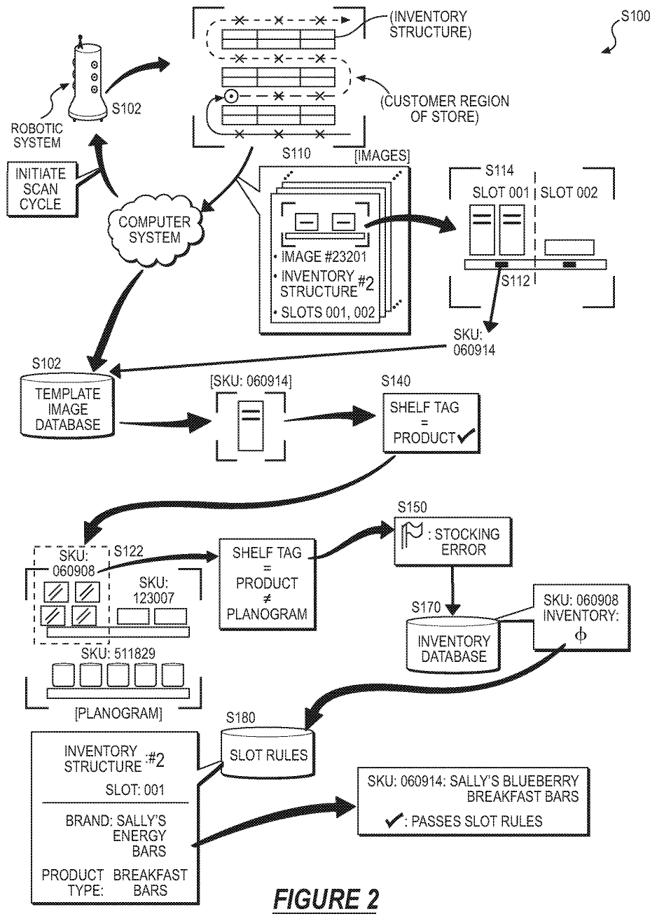

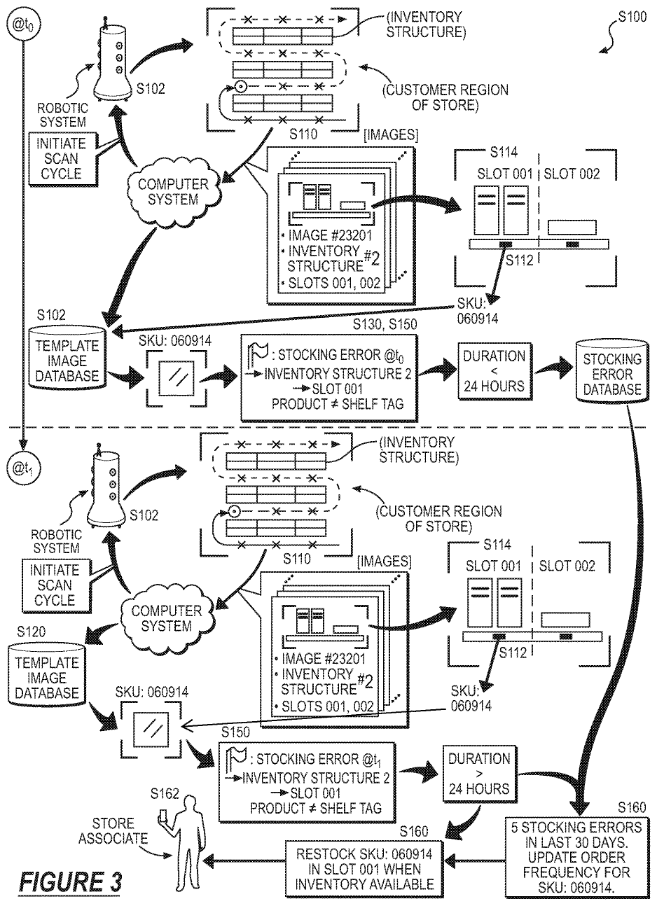

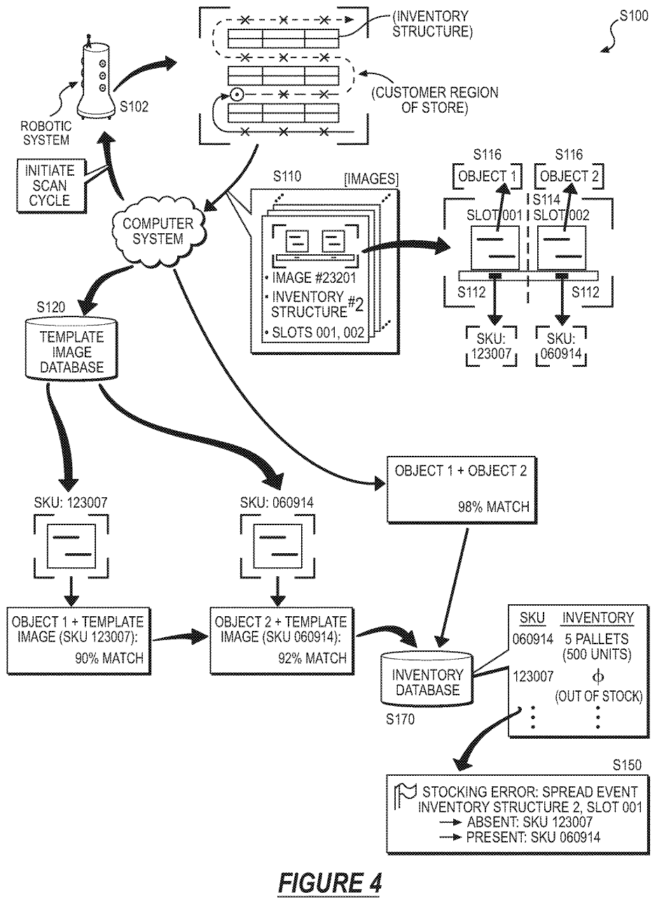

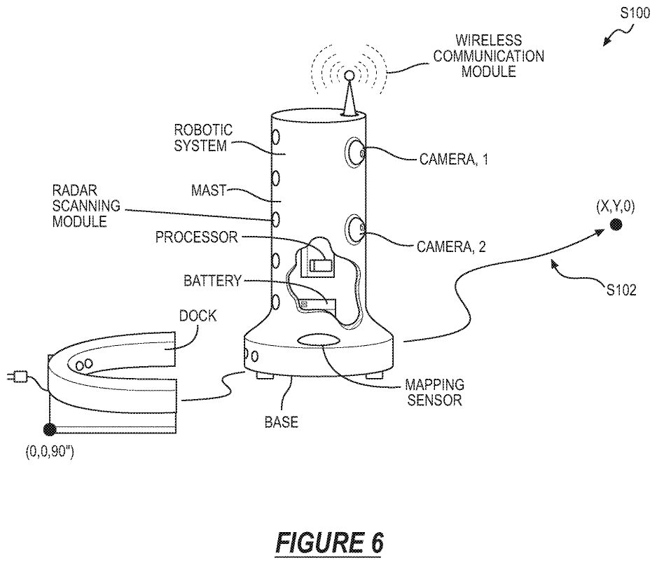

As shown in FIGS. 1A, 1B, 1C, 1D, and 2-6, a method S100 includes, at a robotic system, autonomously navigating throughout regions of a facility to capture images of inventory structures, arranged throughout the facility, via an optical sensor integrated into the robotic system in Block S102. The method S100 further includes, at a computer system: accessing a first image of a first inventory structure captured by the robotic system at a first time in Block S110; detecting a first shelf tag on a first shelf of the first inventory structure depicted in the first image, the first shelf tag including a first product identifier in Block S112; identifying a first slot boundary of a first slot on the first inventory structure based on a first location of the first shelf tag on the first shelf in Block S114; detecting a first object arranged within the first slot boundary on the first shelf in Block S116; and accessing a first template image, in a set of template images, associated with the first product identifier and stored in a template image database in Block S120.

The method S100 further includes, in response to the first object differing from the first template image: interpreting absence of a product unit of a first product type in the first slot on the first shelf, the first product type assigned to the first product identifier in Block S130; detecting a second shelf tag on the first shelf depicted in the first image and adjacent the first shelf tag, the second shelf tag including a second product identifier in Block S112; identifying a second slot boundary of a second slot on the first shelf based on a second location of the second shelf tag on the first shelf in Block S114; and accessing a second template image, in the set of template images, associated with the second product identifier in Block S120.

The method S100 further includes, in response to the first object corresponding to the second template image: confirming presence of a product unit of a second product type in the first slot, the second product type assigned to the second product identifier in Block S140; flagging the first image as depicting a first spread event characterized by presence of product unit of the second product type, assigned to the second slot, in the first slot assigned to the first product type in Block S150; generating an electronic notification indicating detection of the first spread event at the first slot in Block S160; and transmitting the electronic notification to a facility associate affiliated with the facility in Block S162.

As shown in FIG. 1A, one variation of the method S100 includes: triggering a robotic system to autonomously navigate throughout regions of a facility and to captures images of inventory structures in the facility in Block S102; accessing a first image of an inventory structure captured by the robotic system at a first time in Block S110; locating a first shelf spanning a lateral sequence of slots in the inventory structure depicted in the first image; locating a first shelf tag—including a first product identifier—on the first shelf depicted in the first image in Block S112; identifying a first tag-defined slot boundary for a first slot on the first shelf based on a location of the first shelf tag on the first shelf in Block S114; detecting a first object arranged within the first slot boundary on the first shelf in Block S116; and accessing a first template image—stored in a template image database—corresponding to the first product identifier in Block S120.

The method S100 further includes, in response to the first object differing from the first template image: interpreting absence of a product unit of a first product type—assigned to the first product identifier—in the first slot on the first shelf in Block S130; locating a second shelf tag—including a second product identifier—on the first shelf depicted in the image and adjacent the first shelf tag in Block S112; identifying a second tag-defined slot boundary for a second slot on the first shelf based on a location of the second shelf tag on the first shelf in Block S114; and accessing a second template image—stored in the template image database—corresponding to the second product identifier in Block S120.

The method S100 further includes, in response to the first object in the first tag-defined slot boundary corresponding to the second template image: confirming presence of a product unit of a second product type—assigned to the second product identifier—on the first shelf in the first slot in Block S140; flagging the first image as depicting a spread event corresponding to spread of product unit of the second product type into the first slot assigned to the first product type in Block S150; generating a report indicating detection of the spread event and the product unit of the second product type in the first slot in Block S160; and transmitting the report to a facility associate affiliated with the facility in Block S162.

One variation of the method S100 includes, at a robotic system, autonomously navigating throughout regions of a facility to capture images of inventory structures, arranged throughout the facility, via an optical sensor integrated into the robotic system in Block S102. In this variation, the method S100 further includes, at a computer system: accessing a first image of a first inventory structure captured by the robotic system at a first time in Block S110; identifying a first slot boundary of a first slot on the first inventory structure based on a first location of a first shelf tag arranged on the first shelf, the first shelf tag including a first product identifier associated with a first product type in a set of product types in Block S114; detecting a first object arranged within the first slot boundary in the first image in Block S116; identifying a second slot boundary of a second slot on the first inventory structure based on a second location of a second shelf tag arranged on the first shelf, the second shelf tag including a second product identifier associated with a second product type in the set of product types in Block S114; detecting a second object arranged within the second slot boundary in the first image in Block S116; and, based on a first correlation between a first set of visual features extracted from a first region of the first image depicting the first object and a second set of visual features extracted from a second region of the first image depicting the second object, identifying the first object and the second object as a product type. In this variation, in response to the first product type associated with the first product identifier differing from the second product type associated with the second product identifier, the method S100 further includes: accessing a first template image, in a set of template images, associated with the first product identifier in Block S120; extracting a first set of template visual features from the first template image; and, based on a second correlation between the first set of template visual features, the first set of visual features, and the second set of visual features, predicting that the product type corresponds to the first product type in Block S140. In this variation, in response to predicting the product type corresponds to the first product type, the method S100 further includes: flagging the first image as depicting a first spread event characterized by presence of product unit of the first product type, assigned to the first slot, in the second slot assigned to the second product type in Block S150; generating an electronic notification indicating detection of the first spread event at the second slot in Block S160; and transmitting the electronic notification to a facility associate affiliated with the facility in Block S162.

1.1 Method: Empty Slot+Product “plug”

As shown in FIG. 1A, one variation of the method S100 includes, at a robotic system, autonomously navigating throughout regions of a facility to capture images of inventory structures, arranged throughout the facility, via an optical sensor integrated into the robotic system in Block S102. In this variation, the method S100 further includes, at a computer system: accessing a first image of an inventory structure captured by the robotic system at a first time in Block S110; detecting a first shelf tag on a first shelf depicted in the first image, the first shelf tag including a first product identifier in Block S112; identifying a first slot boundary for a first slot on the first shelf based on a location of the first shelf tag on the first shelf in Block S114; and detecting absence of objects arranged within the first slot boundary on the first shelf in the first image in Block S118. In this variation, the method S100 further includes, at the computer system, in response to detecting absence of objects arranged within the first slot boundary: identifying a first product type, in a set of product types, assigned to the first product identifier; accessing an inventory log specifying location of stock of products within the facility in Block S170; and accessing a first quantity of product units of the first product type available in the facility and specified in the inventory log. In this variation, at the computer system, in response to the first quantity of product units of the first product type falling below a threshold quantity, the method S100 further includes: accessing a set of slot rules assigned to the first slot on the first shelf in Block S180; based on the set of slot rules and the inventory log, selecting a second product type for stocking in the first slot on the first shelf in replacement of the first product type in Block S182; generating an electronic notification indicating absence of stock of the first product type and comprising a prompt to restock the first slot on the first shelf with a second quantity of product units of the second product type in Block S160; and transmitting the electronic notification to an associate affiliated with the facility in Block S162.

In one variation, the method S100 includes: triggering a robotic system to autonomously navigate throughout regions of a facility and to captures images of inventory structures in the facility in Block S102; accessing a first image of an inventory structure captured by the robotic system at a first time in Block S110; locating a first shelf spanning a lateral sequence of slots in the inventory structure depicted in the first image; locating a first shelf tag—including a first product identifier—on the first shelf depicted in the first image in Block S112; identifying a first tag-defined slot boundary for a first slot on the first shelf based on a location of the first shelf tag on the first shelf in Block S114; and detecting absence of objects arranged within the first slot boundary on the first shelf in Block S118.

The method S100 further includes, in response to detecting absence of objects arranged within the first slot boundary: identifying a first product type, in a set of product types, assigned to the first product identifier; accessing an inventory log specifying location of stock of products within the facility in Block S170; and accessing a first quantity of product units of the first product type available in the facility and specified in the inventory log. In response to the first quantity of product units of the first product type falling below a threshold quantity, the method S100 further includes: accessing a set of slot rules assigned to the first slot on the first shelf in Block S180; based on the set of slot rules and the inventory log, selecting a second product type—in replacement of the first product type—for stocking in the first slot on the first shelf in Block S182; generating a notification indicating absence of stock of the first product type and including a prompt to restock the first slot on the first shelf with a second quantity of product units of the second product type in Block S160; and transmitting the notification to an associate affiliated with the facility in Block S162.

### 1.2 Stocking Error Event+Performance Characterization

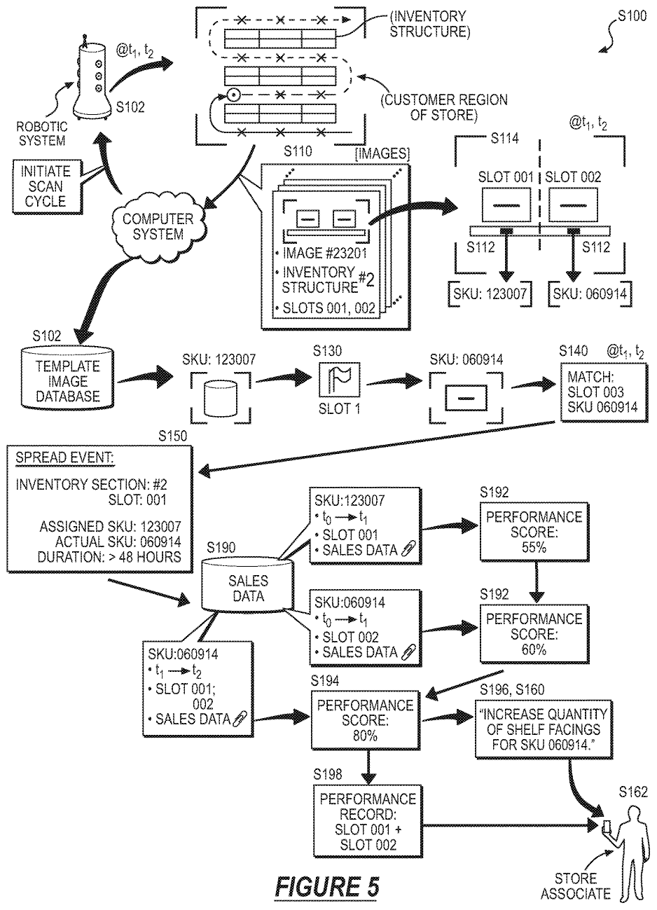

As shown in FIG. 5, one variation of the method S100 includes, at a robotic system, autonomously navigating throughout regions of a facility to capture images of inventory structures, arranged throughout the facility, via an optical sensor integrated into the robotic system in Block S102. In this variation, the method S100 further includes, at a computer system: accessing a first image of a first inventory structure captured by the robotic system at a first time in Block S110; identifying a first slot boundary of a first slot on the first inventory structure based on a first location of a first shelf tag arranged on the first shelf, the first shelf tag including a first product identifier in Block S114; and detecting a first object arranged within the first slot boundary in the first image in Block S116. In this variation, in response to the first object differing from a first template image, in a set of template images, associated with the first product identifier, the method S100 further includes, at the computer system: interpreting absence of a product unit of a first product type in the first slot on the first shelf, the first product type assigned to the first product identifier in Block S130; and, in response to the first object corresponding to a second template image, in the set of template images, associated with a second product identifier assigned to a second product type, flagging the first image as depicting a first stocking error event characterized by occupation of product units of the second product type in the first slot in Block S150.

In this variation, in response to detection of the first stocking error event, the method S100 further includes, at the computer system: accessing a first set of sales data associated with the second product type during an initial time period succeeding the first spread event in Block S190; based on the first set of sales data, estimating a first performance score for the second product type occupying a second slot during the initial time period in Block S192; accessing a second set of sales data associated with the second product type during the first stocking error event in Block S190; and, based on the second set of sales data, estimating a second performance score for the second product type occupying the first slot and the second slot during the first stocking error event in Block S194. In this variation, in response to the second performance score exceeding the first performance score, the method S100 further includes, at the computer system, generating a report indicating detection of the first stocking error event in Block S160 and including a prompt to increase a quantity of slots occupied by the second product type in Block S196; and transmitting the report to a facility associate affiliated with the facility in Block S162.

In one variation, in response to the second performance score falling below the first performance score, the method S100 further includes, at the computer system, accessing an inventory stock condition of the first product type in the facility in Block S170. In response to the inventory stock condition specifying absence of product units of the first product type in the facility, the method S100 further includes: generating a prompt to restock the first slot with a quantity of product units of the third product type in replacement of the second product type; generating a report indicating detection of the first stocking error event and including the prompt in Block S160; and transmitting the report to a facility associate affiliated with the facility in Block S162.

### 2. Applications

Generally, a computer system (e.g., a computer server, a computer network) can execute Blocks of the method S100 to: dispatch a robotic system to capture images of products arranged on shelves throughout a retail space (e.g., a grocery store); derive and track stock conditions (e.g., a stocked condition, a low-stock condition, and/or an out-of-stock condition) at a particular individual customer-product facing slot—assigned to a particular product type—in the facility over time based on photographic images captured by the robotic system deployed in the facility; detect instances of product “spread”—corresponding to placement of product of a product type in one or more slots adjacent a slot assigned to the product type and unassigned to the product type—across slots on a shelf in an inventory structure in the facility; detect empty slots omitting product of product types assigned to these slots; and/or selectively suggest replacement product types for re-stocking empty slots assigned to a particular product type responsive to absence of stock of the particular product type elsewhere in the facility (e.g., back-of-store inventory, top-shelf inventory). Additionally, the computer system can selectively prompt a facility associate to: re-stock slots in front-of-store inventory structures with product units of a product type assigned to these slots and/or with product units of a replacement product type; and/or remove product units of a particular product type arranged within a slot and unassigned to the slot.

In particular, in one implementation, the computer system can detect instances of product spread of a particular product type—assigned to a particular slot on a shelf in an inventory structure in a customer region of the facility—based on a difference between a tag-defined slot boundary defined for the slot and an effective slot boundary defined for the particular product type as arranged on the shelf.

For example, the computer system can: access an image of the inventory structure captured by the robotic system; locate a first shelf tag—including a first product identifier—on a shelf depicted in the image; identify a first tag-defined slot boundary for a first slot on the shelf; detect a first object arranged within the first tag-defined slot boundary; access a first template image—stored in a template image database—corresponding to the first product identifier; and, in response to the first object differing from the first template image, interpret absence of a product unit of a first product type—assigned to the first product identifier—in the first slot on the shelf. The computer system can then: locate a second shelf tag—including a second product identifier—on the shelf depicted in the image and adjacent the first shelf tag; identify a second tag-defined slot boundary for a second slot on the shelf; access a second template image—stored in the template image database—corresponding to the second product identifier; and, in response to the first object corresponding to the second template image, confirm presence of a product unit of a second product type—assigned to the second product identifier—in the first slot. Furthermore, the computer system can: detect a second object arranged within the second tag-defined slot boundary; and, in response to the second object corresponding to the second template image, confirm presence of a second product unit of the second product type in the second slot (assigned to the second product type).

The computer system can then: derive an effective slot boundary for the second product type spanning the second slot and a portion of the first slot containing product unit(s) of the second product type; and thus interpret a spread event—corresponding to product of the second product type “spreading” from the second slot into the first slot on the shelf—for the second product type into the first slot.

The computer system can leverage subsequent images—captured by the robotic system—of the inventory structure to track changes in this spread event over time, such as: whether product units of the second product type remain within the first slot; whether the first slot is empty; and/or whether product units of the first product type occupy the first slot in replacement of product units of the second product type, thereby terminating the spread event. The computer system can thus share these insights with a facility associate to provide increased clarity regarding actual product stocked in slots—regardless of whether these products are assigned to the corresponding slot—in the customer region of the facility. By alerting a facility associate of instances of product spread, the computer system can enable the facility associate to better manage and/or re-stock slots of inventory structures with stock assigned to the slot and/or to more efficiently order additional stock of a product type(s) assigned to slots exhibiting product spread.

Furthermore, the computer system can also identify an empty slot on the shelf—omitting product units of a product type assigned to the slot—and selectively notify a facility associate of detection of the empty slot. Additionally, the computer system can selectively suggest a product type of product units for filling the empty slot on the shelf. In particular, in response to flagging a slot—assigned to a first product type—as an empty slot, the computer system can: access an inventory log defined for the facility; and access a quantity of product units of the first product type stored in a back-of-store inventory region of the facility and/or in top-shelf inventory in the facility (e.g., out-of-reach of a store customer) as specified in the inventory log. Then, in response to the quantity of product units falling below the threshold, the computer system can: access a set of slot rules assigned to the slot on the shelf; based on the set of slot rules, select a second product type—in replacement of the first product type—for stocking in the first slot on the first shelf; and generate a notification indicating absence of stock of the first product type and including a prompt to restock the first slot on the first shelf with a quantity of product units of the second product type. For example, the computer system can access a set of slot rules specifying: a particular manufacturer assigned to the slot; a list of sellers or manufacturers of products excluded from stocking the slot; a category (e.g., beverages, snacks, cosmetics, paper products) of products offered in the slot; etc. The computer system can, therefore, ensure a slot is stocked—such as rather than remaining empty—with replacement product relevant and/or approved for stocking in the empty slot.

### 3. Terms

A “store” is referred to herein as a (static or mobile) facility containing one or more inventory structures.

A “product” is referred to herein as a type of loose or packaged good associated with a particular product identifier (e.g., a SKU) and representing a particular class, type, and varietal.

A “unit” or “product unit” is referred to herein as an instance of a product—such as one bottle of detergent, one box of cereal, or package of bottle water—associated with one SKU value.

A “product facing” is referred to herein as a side of a product designated for a slot.

A “slot” is referred to herein as a section (or a “bin”) of a shelf on an “inventory structure” designated for storing and displaying product units of the product type (i.e., of the identical SKU or CPU). An inventory structure can include a shelving segment, a shelving structure, or other product display containing one or more slots on one or more shelves.

A “planogram” is referred to herein as a plan or layout designating display and stocking of multiple product facings across multiple slots, such as: in a particular shelving segment; across a particular shelving structure; across multiple shelving structures within a particular aisle; across multiple aisles in the facility; or throughout the entirety of the facility. In particular, the planogram can specify a target product type, a target product placement, a target product quantity, a target product quality (e.g., ripeness, time to peak ripeness, maximum bruising), and/or a target product orientation for a fully-stocked slot for each slot represented in the planogram. For example, the planogram can define a graphical representation of an inventory structure in the facility, including graphical representations of each slot in this inventory structure, each populated with a quantity of graphical representations of product type assigned to this slot equal to a quantity of product facings assigned to this slot. Alternatively, the planogram can record textual product placement for one or more inventory structures in the facility in the form of a spreadsheet, slot index, or other database.

Furthermore, a “realogram” is referred to herein as a representation of the actual products, actual product placement, actual product quantity, and actual product orientation of products and product units throughout the facility during a scan cycle, such as derived by the computer system according to Blocks of the method S100 based on photographic images and/or other data recorded by the robotic system while autonomously executing scan cycles in the facility.

A “slot map” is referred to herein as a representation of a layout of a set of inventory structures within the facility in a 2D vectorized grid that, for each inventory structure, designates horizontal shelf facings on the inventory structure, vertical gaps between shelving segments of the inventory structure, and individual slots containing product units on the inventory structure. The computer system can initialize the slot map (e.g., when onboarding a new store that does not have or use a planogram for the facility) and populate the slot map based on images captured by a robotic system autonomously navigating the facility during an initial scan cycle.

A “scene” is referred to herein as a grouping of a set of slots on inventory structures within the facility based on a set of common product labels (e.g., a product category, a product attribute such as gluten-free and/or vegan, and/or a promotional status) associated with the product units arranged in the slots and/or a common fixture type between the slots. The computer system can segment all of the slots within the facility into different scenes and, for each slot, annotate the slot map with a slot location, product labels for the product units arranged within the slot, and scene labels associated with the slot. Furthermore, a slot can belong to more than one scene (e.g., a slot can be part of “face wash” scene, a subcategory of the “makeup/beauty” scene, and the “2-for-1 promotion” scene).

The method S100 is described herein as executed by a computer system (e.g., a remote server, a computer network) remote from the robotic system. However, Blocks of the method S100 can be executed locally by one or more robotic systems deployed in a retail space (or store, warehouse, etc.), by a local computer system (e.g., a local server), or by any other computer system.

Furthermore, Blocks of the method S100 are described below as executed by the computer system to identify products, shelf tags, and promotional tags on open shelves in shelving structures within a grocery store. However, the computer system can implement similar methods and techniques to identify products, shelf tags, and promotional tags on cubbies, in a refrigeration unit, on a wall rack, on a freestanding floor rack, on a table, on a hot-food display, or on or in any other product organizer, display, or other inventory structure in a retail space.

### 4. Mobile Robotic System

A robotic system autonomously navigates throughout a facility and records images—such as color (e.g., RGB) images of packaged goods and hyper-spectral images of fresh produce and other perishable goods—continuously or at discrete predefined waypoints throughout the facility during a scan cycle. Generally, the robotic system can define a network-enabled mobile robot that can autonomously: traverse a facility; capture color and/or hyper-spectral images of inventory structure, shelves, produce displays, etc. within the facility; and upload those images to the remote computer system for analysis, as described below.

In one implementation, the robotic system defines an autonomous imaging vehicle including: a base; a drive system (e.g., a pair of two driven wheels and two swiveling castors) arranged in the base; a power supply (e.g., an electric battery); a set of mapping sensors (e.g., fore and aft scanning LIDAR systems); a processor that transforms data collected by the mapping sensors into two-or three-dimensional maps of a space around the robotic system; a mast extending vertically from the base; a set of color cameras arranged on the mast; one or more hyper-spectral sensors (or “cameras,” “imagers”) arranged on the mast and configured to record hyper-spectral images representing intensities of electromagnetic radiation within and outside of the visible spectrum; and a wireless communication module that downloads waypoints and a master map of a facility from a computer system (e.g., a remote server) and that uploads photographic images captured by the camera and maps generated by the processor to the remote computer system. In this implementation, the robotic system can include cameras and hyper-spectral sensors mounted statically to the mast, such as two vertically offset cameras and hyper-spectral sensors on a left side of the mast and two vertically offset cameras and hyper-spectral sensors on the right side of mast. The robotic system can additionally or alternatively include articulable cameras and hyper-spectral sensors, such as: one camera and hyper-spectral sensor on the left side of the mast and supported by a first vertical scanning actuator; and one camera and hyper-spectral sensor on the right side of the mast and supported by a second vertical scanning actuator. The robotic system can also include a zoom lens, a wide-angle lens, or any other type of lens on each camera and/or hyper-spectral sensor.

In one variation described below, the robotic system further includes a wireless energy/wireless charging subsystem configured to broadcast a signal toward a fixed camera installed in the facility in order to recharge this fixed camera. However, the robotic system can define any other form and can include any other subsystems or elements supporting autonomous navigating and image capture throughout a facility environment.

Furthermore, multiple robotic systems can be deployed in a single store and can be configured to cooperate to image shelves within the facility. For example, two robotic systems can be placed in a large single-floor retail store and can cooperate to collect images of all shelves and produce displays in the facility within a threshold period of time (e.g., within one hour). In another example, one robotic system can be placed on each floor of a multi-floor store, and each robotic system can each collect images of shelves and produce displays on its corresponding floor. The remote computer system can then aggregate color and/or hyper-spectral images captured by multiple robotic systems placed in one store to generate a graph, map, table, and/or task list for managing distribution and maintenance of product throughout the facility.

### 4.1 Scan Cycle

In particular, the computer system dispatches the robotic system to: autonomously navigate throughout regions of the facility, such as including a customer region (or “front”) of the facility; and to image inventory structures in the front of the facility.

For example, inventory structures in the front of the facility can include: store shelves; aisle end caps; produce bins; and other structures from which a patron can select a product type. Inventory structures located in the front of the facility can also include “top-shelf” inventory locations, such as non-customer-product facing shelves located overhead customer-product facing slots and configured to store excess and loose product units not returned to the back of the facility after re-stocking of the customer-product facing slots below. Inventory structures in the back of the facility can include structures or areas designated to hold product delivered to the facility—such as stored in boxed formats—before these product units are transferred to the front of the facility during later re-stocking periods. For example, back-of-store inventory structures can include shelving, bins, floor spaces, and receiving areas.

In one implementation, during a scan cycle, the robotic system can: autonomously navigate to an inventory structure in the front of the facility; record an image of the customer-product facing inventory structure via an optical sensor integrated in the robotic system; upload the image to a database; and repeat this process to image each other customer-product facing inventory structure in the front of the facility during the scan cycle.

Additionally or alternatively, in one implementation, the robotic system can: autonomously navigate to an inventory structure in the front of the facility; record a sequence of photographic images of the customer-product facing inventory structure via the optical sensor while traversing an aisle in the facility facing the first inventory structure; and upload the sequence of images to a database. The computer system can then: access the sequence of photographic images captured by the optical sensor in the robotic system during the first scan cycle; and compile the sequence of photographic images into an image (e.g., a singular image) defining a first composite photographic image depicting a set of shelving segments spanning the inventory structure.

The computer system can then retrieve a first image captured by the remote computer system during this scan cycle and implement computer vision techniques described below and in U.S. patent application Ser. No. 15/600,527, filed on 19-MAY-2017, which is incorporated in its entirety by this reference: to detect regions of the image depicting individual slots (e.g., based on positions of shelf tags detected in the image, based on positions of product units detected in the image, or based on slot location defined in a planogram); to retrieve template visual features of known product types assigned to these slots (e.g., according to shelf tags or the planogram); to extract features from these regions of the image; to detect and identify product units in these slots based on congruence of features extracted from corresponding regions of the image and template visual features representing these known product types; and to compile locations and product types of these product units into stock conditions of each slot detected in the image.

### 5. Tag-Defined Slot Boundaries

Generally, the computer system can: extract features from an image'captured by the robotic system—depicting an inventory structure in the facility; detect shelf tags across the inventory structure and in the image based on these features; and delineate individual slots on the inventory structure based on locations of these shelf tags on the inventory structure.

In one implementation, the computer system can detect a first slot in the inventory structure based on a position of a first shelf tag detected in the image. For example, the computer system can scan laterally across a first shelf face region—extracted from the image—for a shelf tag. Upon detecting a shelf tag in this first shelf face region, the computer system can delineate a slot boundary for the slot corresponding to the shelf tag—for example, extending vertically between the first shelf face and a second shelf face above the first shelf face and extending laterally between a first distance (e.g., 20 centimeters) to the left of a left edge of the shelf tag and a second distance (e.g., 300 centimeters) to the right of a right edge of the shelf tag.

Thus, the computer system can: detect a first shelf tag on the inventory structure in the image; delineate a first slot based on a position of the shelf tag in the image; extract a set of features from the first shelf tag detected in the image (such as including a barcode); identify a first product identifier (e.g., a SKU value, a product description, and current product pricing) of a first product type corresponding to the first shelf tag based on the set of features; identify the first product type based on the product identifier (e.g., by querying a product database); and link a slot address for the first slot directly to the first product identifier and/or first product type.

### 5.1 Identify Product Types in Slot

Generally, within each slot boundary on the shelf and/or inventory structure, the computer system can identify a product type of product units arranged within the slot boundary on the shelf.

In particular, the computer system can: detect a set of objects in a region of the image corresponding to the slot boundary; access a template image—in a template image database—corresponding to a SKU in the shelf tag for the slot boundary; and match the template image to the set of objects detected in the slot boundary. In one implementation, the computer system: implements computer vision techniques to detect a product label (e.g., a shelf tag) on a shelf within the image; reads a barcode, QR code, SKU, product description, and/or other product identifier on the product label in the image; selects a set of template images tagged with the same barcode, QR code, SKU, product description, facing count, and/or other product identifier; and assigns the set of template images to a slot region in the image proximal (e.g., above) the product label.

Then, in response to the template image corresponding to (e.g., matching) the set of objects detected in the slot boundary, the computer system can detect product units of a first product—assigned to the slot boundary and/or corresponding to the shelf tag—within the slot. Alternatively, in response to the template image differing from the set of objects detected in the slot boundary, the computer system can search additional template images in the template database in order to identify a particular template image corresponding to (e.g., matching) the set of objects. In particular, the computer system can search for template images of product types assigned to slots or slot boundaries adjacent and/or contiguous the slot boundary.

For example, the computer system can: detect a first shelf tag—including a first product identifier associated with a first product type—on a shelf of an inventory structure depicted in an image; identify a first slot boundary of a first slot on the shelf of the inventory structure based on a first location of the first shelf tag on the shelf; extract a set of visual features from a region of the image depicting a first object arranged within the first slot; extract a first set of template visual features from a first template image—stored in a template image database—associated with the first product identifier; characterize a first difference between the set of visual features and the first set of template visual features; and, in response to the first difference exceeding a threshold difference, interpret absence of a product unit of the first product type in the slot. The computer system can then: detect a second shelf tag—including a second product identifier associated with a second product type—on the shelf of the inventory structure and adjacent the first shelf tag; extract a second set of template visual features from a second template image associated with the second product identifier; characterize a second difference between the set of visual features and the second set of template visual features; and, in response to the second difference falling below the threshold difference, confirm presence of a product unit of the second product type in the first slot. Therefore, the computer system can distinguish between various product types arranged across adjacent slots, thereby enabling accurate detection and/or characterization of product placement on shelves throughout the facility.

In particular, in one example, the computer system can access an image of a shelf stocked with multiple varieties of pasta sauces with similar packaging and/or color schemes. The computer system can: extract a set of visual features such as related to colors, color gradients, reflectivity, shape, aspect ratio, size and/or dimensions, presence of text, font type or style, text placement, presence of imagery or logos or other iconography, etc.—from a detected jar of pasta sauce in a slot on the shelf; compare this set of visual features to template features associated with different sauce variants; and identify and/or predict that the detected jar of pasta sauce corresponds to a garlic-flavored sauce variant rather than a marinara sauce variant assigned to the slot. Therefore, the computer system can differentiate between closely related products at the SKU level, thereby reducing errors in identifying product types occupying slots in inventory structures across visually similar product types.

### 5.2 Effective Slot Boundary

In one implementation, the computer system implements the methods and techniques described above to: delineate an array of slots on the inventory structure depicted in the image based on detection of shelf tags in the image; and, at each slot in the corpus of slots, identify a product type of product units stored within the slot based on template images corresponding to each product type. Then, the system can identify continuous groupings of the same product type to delineate effective (or “actual”) slot boundaries for each product type.

In particular, the computer system can: identify whether a slot is empty (e.g., contains no product units); and identify whether a slot contains a product unit(s) and/or a product type of product units present in the slot. Based on the product type of product units contained in one or more slots across the shelf, the computer system can define effective slot boundaries for each product type.

For example, the computer system can: access an image of an inventory structure captured by the robotic system; locate a first shelf spanning a lateral sequence of slots in the inventory structure depicted in the image; locate a first shelf tag—including a first product identifier—on the first shelf depicted in the image; define a first slot boundary for a first slot on the first shelf based on a location of the first shelf tag on the shelf; detect a first object arranged within the first slot boundary on the first shelf; access a first template image—stored in a template image database—corresponding to the first product identifier; and, in response to the first object corresponding to the first template image, confirm presence of a first product unit of a first product type—assigned to the first product identifier—in the first slot on the first shelf. The computer system can then: identify a second object arranged within the first slot boundary on the first shelf; and, in response to the second object corresponding to the template image, confirm presence of a second product unit of the first product type—assigned to the first product identifier—in the first slot on the first shelf. The computer system can thus group the first object and the second object in the image—corresponding to the first product unit and the second product unit of the first product type—in a first product group of product units of the first product type assigned to the first slot.

Then, the computer system can: locate a second shelf tag—including a second product identifier—on the first shelf depicted in the image; define a second slot boundary for a second slot on the first shelf based on a location of the second shelf tag on the shelf; detect a third object arranged within the second slot boundary on the first shelf; and access a second template image—stored in a template image database—corresponding to the second product identifier. Then, in response to the third object differing from the second template image, the computer system can: access the first template image corresponding to the first product type; and, in response to the third object corresponding to the first template image, confirm presence of a third product unit of the first product type in the second slot—assigned to the second product type—on the first shelf. The computer system can then group the third object with the first object and the second object in the first product group of product units of the first product type. Based on detection of the third product unit of the first product type outside of the (defined) first slot boundary assigned to the first product type, the computer system can interpret a first effective slot boundary—encompassing the first slot and a portion of the second slot—for product units of the first product type, based on locations of the first, second, and third product unit on the first shelf, the first effective slot boundary exhibiting an effective size exceeding a defined size of the first slot boundary.

Additionally or alternatively, in another example, the computer system can: detect a fourth object arranged within the second slot boundary on the first shelf; and, in response to the fourth object corresponding to the second template image, confirm presence of a first product unit of the second product type in the second slot—assigned to the second product type—on the first shelf. The computer system can then group the fourth object with any additional (and contiguous) objects corresponding to the second product type in a second product group of product units of the second product type. Similarly, the computer system can interpret a second effective slot boundary for the second product group of product units of the second product type based on locations of product units of the second product type on the first shelf. The computer system can repeat this process across the first shelf to: identify a sequence of product groups—including the first product group and the second product group—arranged across the first shelf, each product group corresponding to a particular product type; and delineate an effective slot boundary for each product group in the sequence of product groups.

The computer system can therefore: identify tag-defined slot boundaries in images based on location of shelf tags on shelves in the inventory structure depicted in these images; and define effective slot boundaries based on detection of objects—corresponding to actual product units stored on shelves in the inventory structure—in these images and corresponding to the same product types.

For example, the computer system can: identify 5 shelf tags in an image of a shelf in an inventory structure; and locate 5 slots—and 5 slot boundaries corresponding to the 5 slots—based on locations of the 5 shelf tags on the shelf. However, in response to identifying product units of 3 unique product types on the shelf and spanning the 5 slots, the computer system can delineate 3 effective slot boundaries, such as including a first effective slot boundary for a first product type (e.g., spanning the first and second slot), a second effective slot boundary for a second product type (e.g., spanning the third slot), and a third effective slot boundary for a third product type (e.g., spanning the fourth and fifth slot).

6. Flag Instances of “spread”

Generally, the computer system can detect and/or flag instances of spread events corresponding to “spread” of product units of a first product type into a slot assigned to product units of a second product type differing from the first product type.

### 6.1 Feature Matching

In one implementation, the computer system can detect a spread event by matching objects—detected in images captured by the robotic system—to specific shelf tags depicted in these images.

In particular, the computer system can: access a first image of a first inventory structure captured by the robotic system at a first time; detect a first shelf tag—including a first product identifier—on a first shelf in the first image; identify a first slot boundary for a first slot based on a first location of the first shelf tag; and detect a first object arranged within the first slot boundary. The computer system can further: access a first template image associated with the first product identifier; and, in response to the first object differing from the first template image, interpret absence of a product unit of a first product type—associated with the first product identifier—assigned to the first slot. The computer system can then: locate a second shelf tag—including a second product identifier—adjacent the first shelf tag on the first shelf in the first image; identify a second slot boundary based on a second location of the second shelf tag; access a second template image associated with the second product identifier; and, in response to the first object corresponding to the second template image, confirm presence of a product unit of a second product type—associated with the second product identifier—in the first slot. Then, in response to detection of the product unit of the second product type in the first slot assigned to product units of the first product type, the computer system can: flag the first image as depicting a spread event characterized by placement of the second product type into the first slot assigned to the first product type; generate an electronic notification indicating detection of the spread event; and transmit the electronic notification to a facility associate affiliated with the facility.

Therefore, the computer system can automatically identify and surface instances in which a product of a particular product type occupies a slot assigned to a different product type and adjacent a slot assigned to the product type, thereby enabling more accurate and timely shelf-compliance monitoring and corrective action within the facility.

For example, the computer system can access an image of a cereal shelf in a grocery store. In the image, the computer system can: detect a first shelf tag including a first product identifier corresponding to a regular-size cereal box of a first cereal type; and detect a second shelf tag including a second product identifier corresponding to a family-size cereal box of the first cereal type. The computer system can then: detect a product unit occupying the first slot; and match the product unit to the family-size cereal box of the first cereal type based on template images associated with the second product identifier included on the second shelf tag. The computer system can then confirm presence of the family-size cereal box of the first cereal type across both the first and second slots and thus flag the image as depicting a spread event in which the family-size cereal product occupies the second slot and the first slot assigned to the regular-size cereal box of the first cereal type. The computer system can then generate and transmit a notification to a facility associate indicating detection of the spread event at the cereal shelf.

### 6.1.1 Feature Matching+Inventory Stock Condition

In one implementation, the computer system can leverage known inventory stock conditions of product types to increase confidence in identification of a particular product type on the shelf.

In particular, in this implementation, the computer system can: access a first image depicting a first slot and a second slot adjacent the first slot on a shelf of an inventory structure; detect a first shelf tag—including a first product identifier associated with a first product type—adjacent the first slot on the shelf; detect a second shelf tag—including a second product identifier associated with a second product type—adjacent the second slot on the shelf; detect a first object arranged within the first slot; and detect a second object arranged within the second slot. The computer system can then: extract a first set of visual features from a first region of the first image depicting the first object; access a first template image associated with the first product identifier; extract a first set of template visual features from the first template image; and characterize a first correlation between the first set of visual features and the first set of template visual features. Then, in response to the first correlation falling below a lower threshold correlation, the computer system can: access a second template image associated with the second product identifier; extract a second set of template visual features from the second template image; and characterize a second correlation between the first set of visual features and the second set of template visual features. Then, in response to the second correlation exceeding the lower threshold correlation and falling below an upper threshold correlation, the computer system can: access a first inventory stock condition of the first product type in the facility; access a second inventory stock condition of the second product type in the facility; and, in response to the first inventory stock condition specifying absence of product units of the first product type in the facility and in response to the second inventory stock condition specifying presence of product units of the second product type in the facility, confirm presence of the product unit of the second product type in the first slot.

### 6.1.2 Disambiguating Visually-Similar Product Types

In one implementation, the computer system can leverage known inventory stock conditions of product types to distinguish between visually-similar product types of product units on shelves in the facility.

In particular, in this implementation, the computer system can:
access a first image depicting a first slot and a second slot adjacent the first slot on a shelf of an inventory structure; detect a first shelf tag—including a first product identifier associated with a first product type—adjacent the first slot on the shelf; detect a second shelf tag—including a second product identifier associated with a second product type—adjacent the second slot on the shelf; detect a first object arranged within the first slot; and detect a second object arranged within the second slot. The computer system can then: extract a first set of visual features from a first region of the first image depicting the first object; extract a second set of visual features from a second region of the first image depicting the second object; and characterize a first correlation between the first set of visual features and the second set of visual features. Then, in response to the first correlation exceeding a threshold correlation, the computer system can: access a first template image associated with the first product identifier; access a second template image associated with the second product identifier; extract a first set of template visual features from the first template image; extract a second set of template visual features from the second template image; characterize a second correlation between the first set of visual features and the first set of template visual features; and characterize a third correlation between the first set of visual features and the second set of template visual features.

Then, in response to the second correlation exceeding a threshold correlation and the third correlation exceeding the threshold correlation, the computer system can: access a first inventory stock condition corresponding to the first product type in the facility; and access a second inventory stock condition corresponding to the second product type in the facility. Then, in response to the first inventory stock condition specifying absence of product units of the first product type in the facility and the second inventory stock condition specifying presence of product units of the second product type in the facility, the computer system can: confirm presence of the second product type in the first slot; flag the first image as depicting a spread event characterized by placement of the second product type into the first slot assigned to the first product type; and/or selectively generate an electronic notification indicating detection of the spread event. Alternatively, in response to the first inventory stock condition specifying presence of product units of the first product type in the facility and the second inventory stock condition specifying presence of product units of the second product type in the facility, the computer system can: predict presence of the first product type in the first slot; predict presence of the second product type in the second slot; and withhold generation of the electronic notification.

Therefore, the computer system can resolve ambiguous visual similarity between adjacent product types in slots on the shelf based on inventory availability of these product types, thereby improving accuracy of spread detection when products exhibit similar packaging or appearance.

### 6.2 Effective Slot Boundary V. Actual Slot Boundary

Additionally or alternatively, in one implementation, the computer system can: characterize a difference between the tag-defined slot boundary—defined for a particular product type—and the effective slot boundary defined by a product group of product units of the particular product type detected on the shelf in the image; and, based on the difference, selectively interpret a spread event corresponding to expansion of the slot boundary from the tag-defined slot boundary to the effective slot boundary.

For example, the computer system can: access a first image of the inventory structure captured by the robotic system; locate a first shelf spanning a lateral sequence of slots in the inventory structure depicted in the image; locate a first shelf tag—including a first product identifier—on the first shelf depicted in the image; identify a first tag-defined slot boundary for a first slot on the first shelf based on a location of the first shelf tag on the shelf; detect a first object arranged within the first slot boundary on the first shelf; access a first template image—stored in a template image database—corresponding to the first product identifier; and, in response to the first object differing from the first template image, interpret absence of a product unit of a first product type—assigned to the first product identifier—in the first slot on the first shelf.

The computer system can then: locate a second shelf tag—including a second product identifier—on the first shelf depicted in the image and adjacent the first shelf tag; identify a second tag-defined slot boundary for a second slot on the first shelf based on a location of the second shelf tag on the shelf; access a second template image—stored in the template image database—corresponding to the second product identifier; and, in response to the first object corresponding to the second template image, confirm presence of a product unit of a second product type—assigned to the second product identifier—on the first shelf in the first slot. Furthermore, in response to the second object corresponding to the second template image, the computer system can confirm presence of a second product unit of the second product type on the first shelf in the second slot.

The computer system can therefore: derive an effective slot boundary for the second product type spanning the second slot and a portion of the first slot containing product unit(s) of the second product type. Furthermore, in response to a size of the effective slot boundary for the second product type exceeding a size of the second tag-defined slot boundary, the computer system can: interpret a spread event—corresponding to product of the second product type “spreading” from the second slot into the first slot on the first shelf—for the second product type into the first slot.

Furthermore, in this implementation, the computer system can:
define effective slot boundaries for product types based on observed placement of product units in slots of inventory structures across the facility; and generate a slot map representing these effective slot boundaries—assigned to actual product types occupying these effective slot boundaries—throughout the facility in Block S124. For example, in response to a spread event characterized by presence of a second product type in a first slot—assigned (e.g., by a first shelf tag and/or planogram) to a first product type—on a first shelf of an inventory structure in the facility, the computer system can: define a first effective slot boundary—exhibiting a first size less than a second size of a first tag-defined slot boundary defined for the first product type by a first shelf tag corresponding to the first product type—for the first product type on the first shelf; define a second effective slot boundary exhibiting a third size exceeding a fourth size of a second tag-defined slot boundary defined for the second product type by a second shelf tag corresponding to the second product type—for the second product type on the first shelf; and generate a slot map—depicting effective slot boundaries of slots in inventory structures throughout the facility—depicting the first effective slot boundary assigned to the first product type and the second effective slot boundary assigned to the second product type.

Therefore, the computer system can maintain a slot map depicting actual slot boundaries and actual products on shelves within these actual slot boundaries throughout the facility, thereby providing a real-time representation of actual shelf conditions within the facility and enabling improved inventory planning.

### 6.3 Planogram Compliance

Additionally or alternatively, in one implementation, the computer system can detect a spread event (or continuance of a spread event) based on deviation between a product type occupying a slot—and/or the shelf tag labelling the slot—and a product type assigned to the slot by a planogram defined for the facility. In this implementation, Block S122 of the method S100 recites accessing a planogram defined for the facility, the planogram defining product location assignments for the set of product types throughout the facility.

In particular, the computer system can: access a first image of a first inventory structure captured by the robotic system; detect a first shelf tag—including a first product identifier—on a first shelf in the first image; identify a first slot boundary for a first slot based on a location of the first shelf tag; detect a first object arranged within the first slot boundary; access a first template image associated with the first product identifier; and, in response to the first object corresponding to the first template image, confirm presence of a first product type in the first slot. The computer system can then: access a planogram defining product assignments for slots in the facility; identify a second product type assigned to the first slot by the planogram; and, in response to the first product type differing from the second product type, flag the image as depicting a spread event characterized by placement of the first product type into the first slot assigned to the second product type by the planogram. Therefore, the computer system can detect spread events that persist after updating of shelf tags to reflect replacement products, thereby enabling continued enforcement of planogram compliance despite prior corrective labeling.

For example, at an initial time, the computer system can: access an image depicting a slot in a shelf of an inventory structure; detect a spread event—depicted in the image—in which a sports drink occupies the slot assigned to bottled water; generate a prompt directing an associate to update a shelf tag corresponding to the slot to match the sports drink; and transmit the prompt to a facility associate. At a later time succeeding the initial time, the computer system can: access a new image of the shelf; detect the (updated) shelf tag corresponding to the sports drink adjacent the slot in the new image; detect an object arranged in the slot in the image; access a template image associated with the sports drink; and, in response to the object corresponding to the template image, confirm presence of the sports drink in the slot at the later time. The computer system can then: access a planogram specifying that the slot is assigned to bottled water; and, based on the sports drink differing from the bottled water assigned to the slot, flag the new image as depicting the spread event relative to the planogram.

### 7. Tracking Spread Events Over Time

In one implementation, the computer system can derive and/or estimate a duration of a particular spread event based on images captured of the inventory structure by the robotic system over time.

In particular, in this implementation, the computer system can: access a first image of the inventory structure captured by the robotic system at a first time; locate a first shelf spanning a lateral sequence of slots in the inventory structure depicted in the image; locate a first shelf tag—including a first product identifier—on the first shelf depicted in the image; identify a first tag-defined slot boundary for a first slot on the first shelf based on a location of the first shelf tag on the shelf; detect a first object arranged within the first slot boundary on the first shelf; access a first template image—stored in a template image database—corresponding to the first product identifier; and, in response to the first object differing from the first template image, interpret absence of a product unit of a first product type—assigned to the first product identifier—in the first slot on the first shelf.

The computer system can then: locate a second shelf tag—including a second product identifier—on the first shelf depicted in the image and adjacent the first shelf tag; identify a second tag-defined slot boundary for a second slot on the first shelf based on a location of the second shelf tag on the shelf; access a second template image—stored in the template image database—corresponding to the second product identifier; and, in response to the first object corresponding to the second template image, confirm presence of a product unit of a second product type—assigned to the second product identifier—on the first shelf in the first slot. Furthermore, in response to the second object corresponding to the second template image, the computer system can confirm presence of a second product unit of the second product type on the first shelf in the second slot.

The computer system can therefore: derive an effective slot boundary for the second product type spanning the second slot and a portion of the first slot containing product unit(s) of the second product type. Furthermore, in response to a size of the effective slot boundary for the second product type exceeding a size of the second tag-defined slot boundary, the computer system can interpret a spread event—corresponding to product of the second product type “spreading” from the second slot into the first slot on the first shelf—for the second product type at the first time into the first slot.

Later, the computer system can: access a second image of the inventory structure captured by the robotic system at a second time succeeding the first time; locate the first shelf in the second image; locate the first shelf tag depicted in the second image; identify the first tag-defined slot boundary; and detect a first object arranged within the first slot boundary at the second time in the second image. Then, in response to the first object corresponding to the second template image, the computer system can: confirm presence of a product unit of the second product type on the first shelf in the first slot at the second time; and interpret a spread event—corresponding to product of the second product type “spreading” from the second slot into the first slot on the first shelf—for the second product type at the second time into the first slot.

Later, following an additional scan cycle by the robotic system, the computer system can: access a third image of the inventory structure captured by the robotic system at a third time succeeding the second time; locate the first shelf in the third image; locate the first shelf tag depicted in the third image; identify the first tag-defined slot boundary; detect a first object arranged within the first slot boundary at the third time in the third image; and, in response to the first object corresponding to the first template image, confirm presence of a product unit of the first product type on the first shelf in the first slot at the third time. The computer system can then: confirm termination of the spread event for the second product type into the first slot; estimate a duration of the spread event based on a difference between the first time and the second time; and generate a spread event report indicating occurrence of the spread event—for the second product type into the first slot assigned to the first product type—over the duration.

### 8. Flag Empty Slots

The computer system can also: identify an empty slot on the shelf omitting product units of a product type assigned to the slot; and selectively notify a facility associate of detection of the empty slot.

For example, the computer system can: access an image of the inventory structure captured by the robotic system; locate a first shelf tag—including a first product identifier—on a first shelf depicted in the image; identify a first tag-defined slot boundary for a first slot on the first shelf based on a location of the first shelf tag on the shelf; detect absence of objects within the first slot boundary; identify a first product type, in a set of product types, assigned to the first product identifier; generate a notification indicating absence of product units of the first product type in the first slot; and transmit the notification to a facility associate.

Additionally, in one implementation, the computer system can selectively suggest a product type of product units for filling the empty slot on the shelf. In particular, in this implementation, the computer system can initially verify whether additional stock of product units of a product type—assigned to an empty slot—is present elsewhere in the facility.

For example, in response to flagging a slot—assigned to a first product type—as an empty slot, the computer system can: access an inventory log defined for the facility; access a quantity of product units of the first product type stored in a back-of-store inventory region of the facility and/or in top-shelf inventory in the facility (e.g., out-of-reach of a store customer) as specified in the inventory log; and, in response to the quantity of product units exceeding a threshold, generate a prompt to fill the empty slot with product units of the first product type from the back-of-store inventory region of the facility and/or in top-shelf inventory and transmit the prompt to the facility associate.

Alternatively, in response to the quantity of product units falling below the threshold, the computer system can selectively suggest an alternate product type of product units for filling the empty slot. For example, the computer system can selectively suggest to fill the empty slot with product units of a second product type: similar to the first product type, such as a flavor variant and/or within the same product category (e.g., candy, soda, household paper products, cosmetics); produced by the same manufacturer; exhibiting relatively high sales velocity; assigned to a slot adjacent the first slot on the shelf; etc. The computer system can also: generate a temporary shelf tag for the first slot corresponding to the second product type; generate a prompt to fill the empty slot with product units of the second product type from the back-of-store inventory region of the facility and/or top-shelf inventory; and transmit the prompt—in combination with the temporary shelf tag—to the facility associate.

### 9. Facility Notifications

Generally, the computer system can selectively notify the facility associate(s) of detected stocking error events (e.g., a spread event, a plug event). Furthermore, the computer system can selectively prompt the facility associate to execute various actions responsive to detection of stocking error events, such as including: replacing one or more shelf tags to reflect actual product on a shelf; restocking of slots throughout the facility with assigned product in replacement of mismatched products; adjust orders for specific product types based on availability of these product types in the facility over time; etc.

### 9.1 Selective Notification: Duration

In one implementation, the computer system can selectively generate and transmit notifications responsive to detection of a stocking error event (e.g., a spread event, a plug event) based on a duration of the stocking error event.

In particular, in this implementation, the computer system can: access a first image of a first slot—assigned to a first product type—on a shelf of an inventory structure captured by the robotic system at a first time; detect a product unit of a second product type occupying the first slot in the first image at the first time; and flag the first image as depicting a first spread event characterized by presence of the second product type in the first slot assigned to the first product type. Later, the computer system can: access a second image of the first slot on the shelf of the inventory structure captured by the robotic system at a second time succeeding the first time by a first duration; detect a product unit of the second product type occupying the first slot in the second image; and flag the second image as depicting continuation of the first spread event. Then, in response to the first duration falling below a threshold duration (e.g., 1 hour, 4 hours, 24 hours), the computer system can withhold generation of an electronic notification indicating detection of the first spread event. Alternatively, in response to the first duration exceeding the threshold duration, the computer system can: generate an electronic notification indicating detection of the first spread event at the first slot over the first duration; and transmit the electronic notification to a facility associate affiliated with the facility. Therefore, the computer system can selectively suppress generation of notifications for transient shelf disturbances, thereby enabling reduction of unnecessary alerts and reducing a signal-to-noise ratio of notifications transmitted to facility associates.

Additionally or alternatively, the computer system can then: selectively generate a prompt to maintain placement of the second product type in the first slot, such as based on a set of slot rules defined for the first slot and/or predicted performance of the second product type in the first slot; or generate a prompt to replace the second product type with a third product type in the first slot. Furthermore, in response to the first duration exceeding the threshold duration, the computer system can generate a prompt to update a shelf tag associated with the first slot to correspond to a product type—such as the second product type or the third product type—occupying the first slot in replacement of the first product type. The computer system can then generate an electronic notification including one or more of these prompts and transmit the electronic notification to a facility associate associated with the facility.

### 9.2 Product Restocking

Additionally or alternatively, in another implementation, the computer system can selectively transmit and/or present notifications—indicating stocking error events (e.g., a spread event, a plug event—to the store associate based on current inventory stock conditions of relevant product types in the facility.

In particular, in this implementation, the computer system can: implement the methods and techniques described above to detect a spread event at a first slot assigned to first product type and currently occupied by a second product type at a first time; access a first inventory stock condition of the first product type at the first time; and, in response to the first inventory stock condition specifying absence of product units of the first product type in the facility at the first time, generate an electronic notification indicating detection of the first spread event and the first inventory stock condition; and insert the electronic notification into a list of stocking errors rendered within an associate portal accessed via a mobile device by the facility associate. Later, the computer system can: implement the methods and techniques described above to detect continuation of the spread event at the first slot assigned to the first product type and currently occupied by the second product type at a second time succeeding the first time; access a second inventory stock condition of the first product type at the second time; and, in response to the second inventory stock condition specifying presence of product units of the first product type in the facility at the second time, generate a prompt to restock the first slot with a quantity of product units of the first product type; and insert the prompt into a list of re-stocking prompts—exhibiting higher priority to the list of stocking errors—rendered within the associate portal. Therefore, the computer system can prioritize surfacing of actionable information to store associates as inventory changes in the facility, thereby improving task prioritization and efficiency of restocking slots with correct product throughout the facility.

### 9.2.1 Verification of Restocking Task

In one variation, the computer system can verify whether a facility associate correctly restocks a slot with a product type assigned to the slot responsive to receiving confirmation of restocking of the slot from the facility associate in Block S166.

In particular, at a first time, the computer system can: implement the methods and techniques described above to detect a first spread event characterized by placement of a second product type in a first slot assigned to a first product type; generate a prompt to restock the first slot with product units of the first product type; and transmit the prompt to a facility associate. Later, in response to receiving confirmation of re-stocking of the first slot with product units of the first product type by the facility associate, the computer system can: trigger the robotic system to capture a second image of the first slot at a second time succeeding the first time; detect a first shelf tag—including a first product identifier associated with the first product type in the second image; detect an object arranged within a first slot boundary defined by the first shelf tag—in the second image; and access a first template image associated with the first product identifier. The computer system can then: compare visual features extracted from a region of the second image depicting the object to template visual features extracted from the first template image; and, in response to correspondence between visual features extracted from the region of the image depicting the object and the template visual features of the first template image, confirm presence of a product unit of the first product type in the first slot. The computer system can then: confirm termination of the spread event; close the re-stocking task associated with the first slot; and remove the spread event from a list of active shelf errors generated for the facility. Alternatively, in response to visual features of the object differing from template visual features of the first template image, the computer system can: interpret absence of the first product type in the first slot; predict that the facility associate did not correctly re-stock the first slot with the first product type; generate a second alert indicating incorrect re-stocking of the first slot; and transmit the second alert to the facility associate for appropriate correction.

### 9.3 Replace Shelf Tag

In one variation, the computer system can selectively prompt a facility associate to update shelf labeling in Block S164, such as in response to detection of a stocking error event (e.g., a spread event, a plug event) and based on current inventory conditions associated with a product type assigned to a slot. In particular, in response to flagging an image as depicting a spread event, the computer system can: access an inventory stock condition of a first product type assigned to a first slot; and, in response to the inventory stock condition specifying absence of product units of the first product type in the facility, generate a prompt to replace a first shelf tag with a second shelf tag including a second product identifier corresponding to a second product type occupying the first slot. The computer system can then: generate an electronic notification indicating detection of the spread event and including the prompt; and transmit the electronic notification to a facility associate affiliated with the facility. Therefore, the computer system can dynamically align shelf labeling with actual product placement in response to out-of-stock conditions, thereby enabling increased accuracy in customer-facing information and reduced customer confusion at the shelf.

For example, the computer system can detect that a first slot—assigned to a strawberry-flavored yogurt—on a first shelf is occupied by a blueberry-flavored yogurt and can access inventory data indicating that no units of the strawberry-flavored yogurt are available in the facility. The computer system can then: generate a prompt to replace a first shelf tag—corresponding to the strawberry-flavored yogurt—arranged proximal the first slot on the first shelf with a second shelf tag corresponding to the blueberry-flavored yogurt currently occupying the first slot; and insert the prompt in a list of tasks displayed to the facility associate within a facility portal accessed on a handheld device carried by the facility associate. Therefore, the computer system can ensure that shelf tags reflect actual product availability on the shelf when products are temporarily unavailable, thereby improving shopper trust and reducing pricing discrepancies.

### 9.4 Product Order Modification

In one implementation, the computer system can: detect repeated out-of-stock conditions for a particular product type over time based on detection of alternative product types at a slot assigned to the particular product type and/or absence of back-of-store inventory of the particular product type; and selectively prompt the facility and/or brand affiliated with the particular product type to modify a product order—such as defining a quantity of product units per order and/or frequency of delivery of product units of the particular product type—defined for the particular product type at the facility.

For example, the computer system can: access a series of images—depicting a slot on a shelf of an inventory structure in the facility—captured by the robotic system across multiple scan cycles, the slot assigned to a first product type by a planogram generated for the facility; during a first time period of a first duration (e.g., exceeding a threshold duration), based on a first subset of images in the series of images, detect a first spread event at the first slot characterized by placement of a second product type—in replacement of the first product type—into the slot; during a second time period of a second duration (e.g., exceeding the threshold duration), based on a second subset of images in the series of images, detect a second spread event at the first slot characterized by placement of a third product type—in replacement of the first product type—into the slot; and, during a third time period of a third duration (e.g., exceeding the threshold duration), based on a third subset of images in the series of images, detect absence of product units of any product type in the slot.

The computer system can further: access an inventory stock condition corresponding to the first product type during the first time period; and, in response to the inventory stock condition specifying absence of product units of the first product type during the first time period, identify a first out-of-stock event for the first product type during the first time period. The computer system can repeat this process during the second and third time periods to similarly identify a second out-of-stock event for the first product type during the second time period and a third out-of-stock event for the first product type during the third time period. The computer system can then: aggregate the first, second, and third out-of-stock events into an inventory report generated for the first product type; and, in response to a frequency of the out-of-stock events exceeding a threshold frequency, generate a recommendation to increase a quantity of the first product type ordered for the facility in subsequent replenishment orders and transmit the recommendation to a facility associate associated with inventory management at the facility.

Therefore, the computer system can identify product types that repeatedly exhibit out-of-stock conditions based on recurring shelf-level substitutions and/or absence of product of these product types on the shelf conditions, thereby enabling proactive adjustment of order quantities for high-demand product types and reducing customer dissatisfaction due to lack of product on shelf.

### 10. Slot Rules

In one implementation, the computer system can access slot rules assigned to each slot to verify whether a replacement product type of product units—loaded in a particular slot in replacement of an original product type assigned to the slot due to absence of stock of the original product type—is a valid replacement product type for this particular slot. For example, the computer system can access a set of slot rules specifying: a particular manufacturer or seller assigned to the slot; a list of sellers or manufacturers of products excluded from the slot; a target value range of products offered in the slot; a category (e.g., beverages, snacks, cosmetics, paper products) of products offered in the slot; etc.

In particular, in this implementation, in response to flagging an image as depicting a spread event—characterized by occupation of a second product type in a first slot assigned to a first product type—the computer system can: access an inventory stock condition of the first product type assigned to the first slot; and, in response to the inventory stock condition specifying absence of product units of the first product type in the facility, access a set of slot rules—such as defining a particular brand affiliated with the first product type—assigned to the first slot. The computer system can then: identify a set of alternative product types based on the set of stocking rules, such as including alternative product types supplied by the particular brand; and, in response to the set of alternative product types omitting a second product type currently occupying the first slot in replacement of the first product type, generate a prompt to replace the second product type with a third product type included in the set of alternative product types. The computer system can then: generate an electronic notification indicating detection of the spread event and including the prompt; and transmit the electronic notification to a facility associate. Therefore, the computer system can ensure that replacement products placed in slots comply with store-specific, brand-specific, and/or product-specific constraints.

In one example, the computer system can: implement the methods and techniques described above to confirm presence of a product unit(s) of a first product type in a slot assigned to a second product type; access a set of slot rules assigned to the slot; access a set of characteristics of the first product type, and, in response to the set of characteristics corresponding to the set of slot rules, verify replacement of the second product type with the first product type in the slot. Alternatively, in response to the set of characteristics of the first product type deviating from the set of slot rules, the computer system can: flag the slot for improper stocking with product units of the first product type; generate a notification indicating improper stocking of the slot and including a prompt to remove stock of the first product type from the slot and/or replace the first product type with a third product type; and transmit the notification to a facility associate.

Additionally or alternatively, in another implementation, the computer system can access slot rules assigned to each slot to selectively suggest a replacement product type for restocking an empty slot on the shelf. For example, the computer system can: access an image of the inventory structure captured by the robotic system; locate a shelf spanning a lateral sequence of slots in the inventory structure depicted in the image; locate a shelf tag—including a product identifier—on the shelf depicted in the image; identify a tag-defined slot boundary for a slot on the shelf based on a location of the shelf tag; and detect absence of objects arranged within the slot boundary. Then, in response to detecting absence of objects arranged within the slot boundary, the computer system can: identify a first product type, in a set of product types, assigned to the product identifier; access a set of slot rules assigned to the slot on the shelf; based on the set of slot rules, select a second product type—in replacement of the first product type—for stocking in the first slot on the first shelf; and generate a notification indicating absence of stock of the first product type and including a prompt to restock the first slot on the first shelf with a quantity of product units of the second product type.

### 11. Performance Tracking

In one implementation, the computer system can: leverage detection and/or persistence of a stocking error event—including a spread event and/or a plug event characterized by placement of a second product type in a slot assigned to a first product type—to derive insights related to performance of the second product type in the slot over time; and selectively generate recommendations to modify placement of product types in the facility based on this performance.

For example, the computer system can: detect a stocking error event at a first slot—assigned to a first product type—on a shelf of an inventory structure; identify a second product type arranged in the first slot in replacement of the first product type; and track the second product type in the first slot across a time period following detection of the stocking error event based on additional images captured by the robotic system across subsequent scan cycles. The computer system can further: access performance data—such as including sales data, sell-through data, inventory depletion rate, rate of sale, dwell time of product units in the slot, frequency of replenishment of the slot, customer interaction data, etc.—corresponding to the second product type during the time period; and characterize a performance metric (or “performance score”) for the second product type occupying the first slot (and/or additional slots occupied by the second product type). The computer system can then: compare the performance metric to baseline performance data corresponding to the second product type in other slots—or when not occupying the first slot—and/or to performance data corresponding to the first product type assigned to the first slot; and, based on this comparison, generate a recommendation to modify placement of one or more product types in the facility. The computer system can then: transmit the recommendation to a facility associate and/or a system associated with a brand affiliated with one or more of the product types.

### 11.1 Performance Report

In one implementation, the computer system can: leverage detection and/or persistence of a stocking error event—such as a spread event characterized by placement of a second product type into a first slot assigned to a first product type—to characterize performance of replacement product types occupying slots assigned to other product types before and during the stocking error event; and generate a performance record corresponding to replacement product types occupying these slots over time in Block S198.

In particular, during an initial time period, the computer system can: confirm presence of product units of a first product type occupying a first slot assigned to the first product type; access a first set of sales data captured for the first product type during the initial time period; estimate a first performance score for the first product type occupying the first slot during the initial time period based on the first set of sales data; confirm presence of product units of a second product type occupying a second slot assigned to the second product type; access a second set of sales data captured for the second product type during the initial time period; and estimate a second performance score for the second product type occupying the second slot during the initial time period based on the second set of sales data. Then, during a first time period succeeding the initial time period and corresponding to a duration of a spread event characterized by occupation of the second product type in the first slot assigned to the first product type, the computer system can: access a third set of sales data captured for the second product type—occupying the first slot—during the first time period; and estimate a third performance score for the second product type occupying the first slot (and the second slot) during the first time period based on the third set of sales data. The computer system can then: generate a performance record including the first performance score associated with the first product type occupying the first slot during the initial time period, the second performance score associated with the second product type occupying the second slot during the initial time period, and the third performance score associated with the second product type occupying the first slot and the second slot during the first time period; and transmit the performance record to a facility associate affiliated with the facility for review.

Therefore, the computer system can characterize performance of product types before and during stocking error events, thereby enabling comparison of baseline product performance and observed performance when a replacement product type occupies a slot assigned to a different product type.

### 11.1 Performance+Suggested Slot Reassignments

Additionally or alternatively, in one implementation, the computer system can leverage observed performance of a replacement product type—occupying a slot designated to an assigned product type—during a stocking error event to selectively suggest modifications to placement of the replacement and/or assigned product type in the facility.

For example, the computer system can implement the methods and techniques described above to: estimate a first performance score for a first product type—assigned to a first slot—occupying the first slot during an initial time period based on a first set of sales data captured during the initial time period; estimate a second performance score for a second product type—assigned to a second slot—occupying the second slot during the initial time period based on a second set of sales data captured during the initial time period; and estimate a third performance score for the second product type—assigned to the second slot—occupying the first slot and the second slot during a first time period succeeding the initial time period based on a third set of sales data captured during the first time period. Then, in response to the third performance score exceeding the first performance score and the second performance score, the computer system can: generate an electronic notification indicating the third performance score and including a prompt to reassign the first slot to the second product type in replacement of the first product type and reassign a third slot to the first product type; and transmit the electronic notification to a facility associate affiliated with the facility for review and/or updating of a planogram defining slot assignments for the facility.

Therefore, the computer system can leverage observed performance of a product type occupying alternative slots—compared to one or more slots assigned to the product type—during a stocking error event to recommend revised placement of product types across shelves in the facility, thereby improving shelf allocation based on measured product performance.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
at a robotic system, autonomously navigating throughout regions of a facility to capture images of inventory structures, arranged throughout the facility, via an optical sensor integrated into the robotic system; and
at a computer system:
accessing a first image of a first inventory structure captured by the robotic system at a first time;
detecting a first shelf tag on a first shelf of the first inventory structure depicted in the first image, the first shelf tag comprising a first product identifier;
identifying a first slot boundary of a first slot on the first inventory structure based on a first location of the first shelf tag on the first shelf;
detecting a first object arranged within the first slot boundary on the first shelf;
accessing a first template image, in a set of template images, associated with the first product identifier and stored in a template image database; and
in response to the first object differing from the first template image:
interpreting absence of a product unit of a first product type in the first slot on the first shelf, the first product type assigned to the first product identifier;
detecting a second shelf tag on the first shelf depicted in the first image and adjacent the first shelf tag, the second shelf tag comprising a second product identifier;
identifying a second slot boundary of a second slot on the first shelf based on a second location of the second shelf tag on the first shelf;
accessing a second template image, in the set of template images, associated with the second product identifier; and
in response to the first object corresponding to the second template image:
confirming presence of a product unit of a second product type in the first slot, the second product type assigned to the second product identifier;
flagging the first image as depicting a first spread event characterized by presence of product unit of the second product type, assigned to the second slot, in the first slot assigned to the first product type;
generating an electronic notification indicating detection of the first spread event at the first slot; and
transmitting the electronic notification to a facility associate affiliated with the facility.

2. The method of claim 1:
further comprising, in response to flagging the first image as depicting the first spread event:
accessing an inventory stock condition of the first product type in the facility; and
in response to the inventory stock condition specifying absence of product units of the first product type in the facility:
accessing a set of stocking rules defined for the facility and comprising a first stocking rule specifying a brand assigned to the first slot and offering a first set of product types comprising the first product type; and
in response to the first set of product types omitting the second product type, generating a prompt to replace product units of the second product type occupying the first slot with product units of a third product type in the first set of product types; and
wherein generating the electronic notification indicating detection of the first spread event comprises generating the electronic notification indicating detection of the first spread event and comprising the prompt.

3. The method of claim 2, further comprising, in response to the first object corresponding to the second template image and in response to the first duration falling below the threshold duration:
flagging the second image as depicting the first spread event; and
withholding generation of the second electronic notification indicating continuation of the first spread event at the first slot.

4. The method of claim 1:
wherein flagging the first image as depicting the first spread event comprises:
interpreting presence of the first spread event characterized by presence of product unit of the second product type in the first slot at the first time; and
flagging the first image as depicting the first spread event; and
further comprising, at a second time succeeding the first time, in response to receipt of a shipment containing stock of product units of the first product type:
generating an electronic notification indicating presence of stock of the first product type in a first inventory location within an inventory region of the facility and comprising a prompt to transfer a first quantity of product units of the first product type from the first inventory location to a first customer location of the first slot on the first shelf on the first inventory structure within a customer region of the facility;
accessing a map of the facility comprising the customer region and the inventory region;
based on the map, generating a route for delivery of product units of the first product type from the first inventory location to the first customer location;
appending the electronic notification with the route; and
transmitting the electronic notification to the facility associate.

5. The method of claim 1, further comprising:
defining a first effective slot boundary for the first product type on the first shelf, the first effective slot boundary exhibiting a first size less than a second size of the first slot boundary defined for the first product type by the first shelf tag;
defining a second effective slot boundary for the second product type on the first shelf, the second effective slot boundary exhibiting a third size
greater than a fourth size of the second slot boundary defined for the second product type by the second shelf tag; and
generating a slot map depicting effective slot boundaries of slots in inventory structures throughout the facility, the slot map depicting the first effective slot boundary assigned to the first product type and the second effective slot boundary assigned to the second product type.

6. The method of claim 1:
further comprising, in response to flagging the first image as depicting the first spread event:
accessing an inventory stock condition of the first product type in an inventory region of the facility; and
in response to the inventory stock condition specifying absence of product units of the first product type in the inventory region of the facility, generating a prompt to replace the first shelf tag with a third shelf tag comprising the second product identifier; and
wherein generating the electronic notification indicating detection of the first spread event comprises generating the electronic notification indicating detection of the first spread event and comprising the prompt.

7. The method of claim 1, further comprising, in response to the first object corresponding to the first template image:
confirming presence of a product unit of the first product type on the first shelf in the first slot;
accessing a planogram defined for the facility, the planogram defining product location assignments for the set of product types throughout the facility;
identifying a third product type assigned to the first slot by the planogram; and
in response to the first product type, associated with the first product identifier specified by the first shelf tag, differing from the third product type assigned to the first slot by the planogram:
flagging the first image as depicting a spread event characterized by presence of product unit of the third product type in the first slot assigned to the first product type;
accessing an inventory stock condition of the first product type in the facility; and
in response to the inventory stock condition specifying availability of product units of the first product type in the facility:
generating an electronic prompt to restock product units of the first product type within the first slot and replace the first shelf tag with a third shelf tag comprising a third product identifier corresponding to the third product type; and
transmitting the electronic prompt to the store associate.

8. The method of claim 1:
wherein interpreting absence of the product unit of the first product type in the first slot in response to the first object differing from the first template image comprises:
extracting a set of visual features from a region of the first image depicting the first object;
extracting a first set of template visual features from the first template image associated with the first product identifier;
characterizing a first difference between the set of visual features and the first set of template visual features; and
in response to the first difference exceeding a threshold difference, interpreting absence of the product unit of the first product type in the first slot; and
wherein confirming presence of the product unit of the second product type in the first slot in response to the first object corresponding to the second template image comprises:
extracting a second set of template visual features from the second template image associated with the second product identifier;
characterizing a second difference between the set of visual features and the second set of template visual features; and
in response to the second difference falling below the threshold difference, confirming presence of the product unit of the second product type in the first slot.

9. The method of claim 1:
wherein generating the electronic notification indicating detection of the first spread event comprises generating the electronic notification indicating detection of the first spread event and comprising a prompt to
re-stock product units of the first product type in the first slot in replacement of product units of the second product type; and
further comprising:
accessing a second image of the first inventory structure captured by the robotic system at a second time succeeding the first time by a first duration;
detecting a second object arranged within the first slot boundary on the first shelf in the second image;
in response to the second object differing from the first template image, interpreting absence of a product unit of the first product type in the first slot on the first shelf at the second time; and
in response to the first object corresponding to the second template image:
confirming presence of a product unit of the second product type in the first slot at the second time;
flagging the second image as depicting the first spread event; and
in response to the first duration exceeding a threshold duration:
interpreting an inventory stock condition for the first product type specifying absence of product units of the first product type in the facility;
generating a prompt to replace the first shelf tag with a third shelf tag comprising the second product identifier;
generating a second electronic notification indicating continuation of the first spread event at the first slot; and
transmitting the electronic notification to the facility associate.

10. The method of claim 1, wherein confirming presence of the product unit of the second product type in the first slot in response to the first object corresponding to the second template image comprises:
estimating a correlation between features of the first object extracted from the first image and template features extracted from the second template image; and
in response to the correlation exceeding a first threshold correlation and falling below a second threshold correlation:
accessing a first inventory stock condition of the first product type in the facility;
accessing a second inventory stock condition of the second product type in the facility; and
in response to the first inventory stock condition specifying absence of product units of the first product type in the facility and in response to the second inventory stock condition specifying presence of product units of the second product type in the facility, confirming presence of the product unit of the second product type in the first slot.

11. The method of claim 1, further comprising:
in response to the first object differing from the second template image:
interpreting absence of a product unit of the second product type in the first slot on the first shelf;
locating a third shelf tag on the first shelf depicted in the first image and adjacent the first shelf tag, the third shelf tag comprising a third product identifier;
identifying a third slot boundary of a third slot on the first shelf based on a third location of the third shelf tag on the first shelf; and
accessing a third template image, in the set of template images, associated with the third product identifier; and
in response to the first object corresponding to the third template image:
confirming presence of a product unit of the third product type in the first slot, the third product type assigned to the third product identifier;
flagging the first image as depicting a second spread event characterized by presence of product unit of the third product type, assigned to the third slot, in the first slot assigned to the first product type,
generating a second electronic notification indicating detection of the second spread event at the first slot; and
transmitting the second electronic notification to the facility associate.

12. The method of claim 1:
wherein transmitting the electronic notification to the facility associate comprises:
accessing a first inventory stock condition of the first product type in the facility at a second time; and
in response to the first inventory stock condition specifying absence of product units of the first product type in the facility:
appending the electronic notification with the inventory stock condition of the first product type;
inserting the electronic notification, describing the first spread event and the inventory stock condition, into a list of stocking errors generated for the facility; and
rendering the list of stocking errors within an associate portal accessed via a computing device associated with the facility; and
further comprising, at a third time succeeding the second time:
accessing a second inventory stock condition of the first product type in the facility at the third time; and
in response to the first inventory stock condition specifying presence of product units of the first product type in the facility:
generating a prompt to re-stock the first slot with a quantity of product units of the first product type;
inserting the prompt in a list of re-stocking prompts generated for the facility; and
rendering the list of re-stocking prompts within the associate portal.

13. The method of claim 1, further comprising, by the computer system, in response to receiving confirmation of re-stocking of the first slot with product units of the first product type by the store associate:
triggering the robotic system to capture a second image of the first inventory structure at a second time succeeding the first time;
detecting the first shelf tag on the first shelf of the first inventory structure depicted in the second image;
identifying the first slot boundary of the first slot on the first inventory structure based on the first location of the first shelf tag on the first shelf;
detecting a second object arranged within the first slot boundary on the first shelf; and
in response to the first object corresponding to the first template image:
confirming presence of a product unit of the first product type in the first slot; and
confirming termination of the first spread event.

14. The method of claim 1, further comprising:
during an initial time period preceding the first time:
confirming presence of product units of the first product type in the first slot;
accessing a first set of sales data captured for the first product type during the initial time period;
estimating a first performance score for the first product type occupying the first slot during the initial time period based on the first set of sales data;
accessing a second set of sales data captured for the second product type during the initial time period; and
estimating a second performance score for the second product type occupying the second slot during the initial time period based on the second set of sales data;
during a first time period succeeding the first time and corresponding to a duration of the first spread event:
accessing a third set of sales data captured for the second product type during the first time period; and
estimating a third performance score for the second product type occupying the first slot and the second slot during the first time period based on the third set of sales data;
generating a performance record comprising:
the first performance score associated with the first product type occupying the first slot during the initial time period;
the second performance score associated with the second product type occupying the second slot during the initial time period; and
the third performance score associated with the second product type occupying the first slot and the second slot during the first time period; and
transmitting the performance record to the facility associate.

15. The method of claim 14, further comprising, in response to the third performance score exceeding the first performance score and the second performance score:
generating a second electronic notification indicating the third performance score and comprising a prompt to:
reassign the first slot to the second product type in replacement of the first product type; and
reassign a third slot to the first product type; and
transmitting the second electronic notification to the facility associate.

16. A method comprising:
at a robotic system, autonomously navigating throughout regions of a facility to capture images of inventory structures, arranged throughout the facility, via an optical sensor integrated into the robotic system; and
at a computer system:
accessing a first image of a first inventory structure captured by the robotic system at a first time;
identifying a first slot boundary of a first slot on the first inventory structure based on a first location of a first shelf tag arranged on the first shelf, the first shelf tag comprising a first product identifier;
detecting a first object arranged within the first slot boundary in the first image;
in response to the first object differing from a first template image, in a set of template images, associated with the first product identifier:
interpreting absence of a product unit of a first product type in the first slot on the first shelf, the first product type assigned to the first product identifier; and
in response to the first object corresponding to a second template image, in the set of template images, associated with a second product identifier assigned to a second product type, flagging the first image as depicting a first stocking error event characterized by occupation of product units of the second product type in the first slot; and
in response to detection of the first stocking error event:
accessing a first set of sales data associated with the second product type during an initial time period succeeding the first stocking error event;
based on the first set of sales data, estimating a first performance score for the second product type occupying a second slot during the initial time period;
accessing a second set of sales data associated with the second product type during the first stocking error event;
based on the second set of sales data, estimating a second performance score for the second product type occupying the first slot and the second slot during the first stocking error event; and
in response to the second performance score exceeding the first performance score:
generating a report indicating detection of the first stocking error event and comprising a prompt to increase a quantity of slots occupied by the second product type; and
transmitting the report to a facility associate affiliated with the facility.

17. The method of claim 16, wherein accessing the second template image associated with the second product identifier assigned to the second product type comprises:
identifying a second slot boundary of a second slot, adjacent the first slot on the first shelf, based on a second location of a second shelf tag on the first shelf, the second shelf tag comprising the second product identifier; and
accessing the second template image associated with the second product identifier.

18. The method of claim 16, further comprising, in response to the second performance score falling below the first performance score:
accessing an inventory stock condition of the first product type in the facility; and
in response to the inventory stock condition specifying absence of product units of the first product type in the facility:
generating a prompt to restock the first slot with a quantity of product units of the third product type in replacement of the second product type;
generating a report indicating detection of the first stocking error event and comprising the prompt; and
transmitting the report to a facility associate affiliated with the facility.

19. A method comprising:
at a robotic system, autonomously navigating throughout regions of a facility to capture images of inventory structures, arranged throughout the facility, via an optical sensor integrated into the robotic system; and
at a computer system:
accessing a first image of an inventory structure captured by the robotic system at a first time;
detecting a first shelf tag on a first shelf depicted in the first image, the first shelf tag comprising a first product identifier;
identifying a first slot boundary for a first slot on the first shelf based on a location of the first shelf tag on the first shelf;
detecting absence of objects arranged within the first slot boundary on the first shelf in the first image;
in response to detecting absence of objects arranged within the first slot boundary:
identifying a first product type, in a set of product types, assigned to the first product identifier;
accessing an inventory log specifying location of stock of products within the facility; and
accessing a first quantity of product units of the first product type available in the facility and specified in the inventory log; and
in response to the first quantity of product units of the first product type falling below a threshold quantity:
accessing a set of slot rules assigned to the first slot on the first shelf;
based on the set of slot rules and the inventory log, selecting a second product type for stocking in the first slot on the first shelf in replacement of the first product type;
generating an electronic notification indicating absence of stock of the first product type and comprising a prompt to restock the first slot on the first shelf with a second quantity of product units of the second product type; and
transmitting the electronic notification to an associate affiliated with the facility.

20. The method of claim 19, further comprising, in response to selecting the second product type for stocking in the first slot in replacement of the first product type:
generating a second prompt to replace the first shelf tag with a second shelf tag comprising a second product identifier associated with the second product type; and
appending the electronic notification with the second prompt.
